(19) United States
(12) Patent Application Publication
(10) Pub. No.: US 2026/0347009 A1
(43) Pub. Date: Nov. 5, 2026

(54) CAPTURE SYSTEM ADAPTED TO CAPTURE SPACE OBJECTS, IN PARTICULAR FOR RECOVERY OR DEORBITING PURPOSES

(71) Applicant: ClearSpace SA, Renens (CH)

(72) Inventors: Noémy Scheidegger, Oberdiessbach (CH); Muriel Richard, Pampigny (CH); Pierre-Alain Mäusli, Cheseaux-Lausanne (CH); Catherine Perroud-Johnson, Cossonay-Ville (CH); Timothée Mion, Montpellier (FR)

(21) Appl. No.: 19/706,390

(22) Filed: Jun. 12, 2026

Related U.S. Application Data
(62) Division of application No. 18/034,738, filed on Oct. 29, 2020, now abandoned.

(51) Int. Cl. B64G 1/22

(52) U.S. Cl. CPC B64G 1/2224; B64G 1/2222

(57) ABSTRACT

A capture system adapted to capture a target space object, including a plurality of articulated arms configured for deployment from a stowed configuration to a deployed configuration. Each articulated arm includes a plurality of articulated arm segments including: a first articulated arm segment coupled at a first proximal end to a spacecraft via a first pivoting joint, and at least a second articulated arm segment coupled at a second proximal end to a first distal end of the first articulated arm segment via a second pivoting joint. Each of the first pivoting joints is located on or close to a front face of the spacecraft facing the space object. In the stowed configuration, the articulated arm segments are stowed backwards from the front face of the spacecraft, and are deployable forward of the front face of the spacecraft to perform capture of the target space object.

### TECHNICAL FIELD

The present invention generally relates to a capture system adapted to capture space objects, in particular space objects orbiting Earth, such as satellites, spacecrafts, parts of launch vehicles, or space debris. This capture system is especially intended to be used with a view to recover or deorbit such space objects.

### BACKGROUND OF THE INVENTION

Orbital debris are becoming an increasingly problematic issue for satellite launches and space missions, and a lot of attention has been focused over the past decades on debris avoidance prediction and debris monitoring. In addition to that, most of, if not all major space agencies are now claiming the need for active debris removal (ADR).

In 2011, about 14′000 debris larger than 10 cm were catalogued in Low Earth Orbit (LEO), and about 2′000 of these were remains of launch vehicles and 10′000 were originating from non-operational satellites. One particularly noticeable event in recent years was the accidental collision on Feb. 10, 2009 between two artificial satellites, the Iridium 33 and Kosmos-2251 communication satellites launched respectively in 1997 and 1993. At the time of the collision, the Iridium 33 was still operational, while the Kosmos-2251 reportedly went out of service in 1995, two years after its launch. This was the first hypervelocity collision to be reported between two artificial satellites. The collision destroyed both satellites and generated a considerable amount of orbital debris. The NASA estimated in 2011 that this particular satellite collision, alone, created more than 2′000 debris larger than 10 cm, and many smaller ones (see e.g. Orbital Debris, Quarterly News, Volume 15, Issue 3, July 2011).

Several initiatives have been launched in recent years to study possible solutions for active debris removal (ADR). One of the most recent initiatives was announced in December 2019 by the European Space Agency (ESA) with the goal to launch the first space mission, codenamed “ClearSpace-1”, in 2025 to remove an ESA owned item of debris from orbit. ClearSpace opted, as a demonstrator for this first space mission, to capture the upper part of the so-called “Vespa” (Vega Secondary Payload Adapter) that was used to deliver multiple payloads in Earth orbit on May 7, 2013 as part of the second flight of ESA's Vega launch vehicle.

Various types of capture solutions and concepts have been contemplated in the art, amongst which capture systems that rely on the use of two or more articulated arms that are coordinated to grip or grasp a target space object.

International (PCT) Publication No. WO 2014/195468 A1 discloses a capture system of the type comprising multiple (e.g. four) articulated arms that are each mechanically coupled to a common pressure element configured to come into direct mechanical contact with the space object to be captured. Upon coming into direct mechanical contact with the space object, the pressure element causes closure of the articulated arms onto the space object. This capture system is contemplated for use in connection e.g. with the capture of a standard upper stage of a launch vehicle (such as the upper stage of an “Ariane 4” rocket) or of a satellite or part thereof. While of a reasonably simple construction, this capture concept is not entirely adequate, especially in that the entire mechanical configuration of the capture system restricts the ability to position the articulated arms in a compact manner on the relevant service spacecraft onto which the capture system is meant to be integrated. This solution is in particular detrimental in that the mechanical arms cannot be stowed in a compact manner during launch of the relevant service spacecraft. The mechanical configuration of the capture system is furthermore such that all articulated arms are moved simultaneously from an open configuration to a close configuration, which means that the capture systems has no particular ability to actively adapt to the actual shape of the target space object to be captured. Moreover, the use of a common pressure element mechanically coupled to the articulated arms is detrimental in that this common pressure element takes a substantial portion of the frontal surface (or X+ face) of the service spacecraft, meaning that this portion cannot be exploited for the purpose of locating required sensory components used for rendezvous operations with the target space object and/or during capture thereof.

International (PCT) Publication No. WO 2016/030890 A1 discloses a capture system of the type comprising multiple (e.g. four) adjustable gripping arms, each provided with a gripping end that is adapted and configured to capture and grip a dedicated target portion of a satellite, namely an interface ring used for interfacing the satellite with a launch vehicle. Each gripping arm is formed of a linkage including an operational rod whose distal end is provided with the gripping end, which operational rod is pivotally connected at two locations along its length to first ends of two cranks. The second ends of the two cranks are pivotally connected to a side of the service spacecraft, thus allowing each gripping arm to be moved between a stowed configuration, along the relevant side of the service spacecraft, and a deployed configuration in which the cranks are pivoted away from the relevant side of the service spacecraft and move the associated operational rod at a distance away from and in front of the service spacecraft. It will be understood that the adjustable gripping arms are not as such designed or configured to grasp the target satellite by positioning the gripping arms around the target satellite, but by gripping and engaging with a dedicated target portion of the satellite (namely the aforementioned interface ring) using the gripping end of the gripping arms. In effect, it can be noted that the gripping arms are solely designed to grip relevant portions of the interface ring by means of the gripping ends and are not as such capable of being or designed to be positioned around the target satellite. This also implies that rendezvous operations must be carried out in such a way that the service spacecraft carrying the capture system is precisely positioned with respect to the target satellite to ensure that the gripping ends are accurately moved into engagement with the target interface ring to properly dock with the target satellite.

Chinese Patent Publication No. CN 106882402 A discloses a capture system of the type comprising multiple (e.g. four) articulated fingers having a plurality of articulated phalanges joined by rotating joints, each rotating joint being equipped with a torsion spring. Each articulated finger is actuated by a common rope or cable that is guided along the rotating joints and about guide wheels that are provided along the length of the articulated phalanges, thereby allowing opening or closing of the articulated fingers around the space object to be captured. The articulated fingers are positioned and distributed about the circumference of a rotatable housing that is configured to rotate about a fixed housing. The articulated fingers can be positioned into a compact stowed configuration, fingers folded around each other on the front and the sides of the rotatable housing.

Chinese Utility Model No. CN 205854540 U discloses a capture system of the type comprising multiple (e.g. four) articulated arms and a central protruding platform provided on the frontal surface (or X+ face) of a service spacecraft, facing the target space object to be captured. Each articulated arm is composed of two arm segments driven by a joint motor. Each of the surface of the central protruding platform and of the inner surface of the arm segments, facing the target space object, is provided with a buffer layer and a force sensor designed to detect contact with the target space object and control the service spacecraft accordingly while the articulated arms are closed onto the target space object.

There remains a need for an improved solution.

### SUMMARY OF THE INVENTION

A general aim of the invention is to remedy the above-noted shortcomings of the prior art.

More precisely, an aim of the present invention is to provide a capture system that occupies a relatively small volume in the stowed configuration and is of lightweight, yet robust construction.

A further aim of the invention is to provide such a capture system that is robust and reliable to operate, while remaining of reasonably simple and cost-efficient construction.

Yet another aim of the invention is to provide such a capture system that is ideally suited to carry out capture of a space object, in particular for recovery or deorbiting purposes.

An aim of the invention is also to provide such a capture system that can adequately be affixed to a spacecraft for the purpose of carrying out recovery or deorbiting missions.

Yet another aim of the invention is to provide a capture system that can adequately dampen and absorb shocks generated upon capture of the space object.

These aims are achieved thanks to the solutions defined in the claims.

There is accordingly provided, in accordance with a first aspect of the present invention, a capture system, the features of which are recited in claim 1, namely a capture system adapted to capture a target space object, comprising a plurality of articulated arms configured to be deployable from a stowed configuration to a deployed configuration to perform capture of the target space object, wherein each articulated arm includes a plurality of articulated arm segments including a first articulated arm segment coupled at a proximal end to a spacecraft or to a platform deployable from said spacecraft via a first pivoting joint and at least a second articulated arm segment coupled at a proximal end to a distal end of the first articulated arm segment via a second pivoting joint. According to this first aspect of the invention, the plurality of articulated arm segments are nestable one within the other, in the stowed configuration, such that the first and second articulated arm segments are intertwined.

By way of preference, the second articulated arm segment is received, in the stowed configuration, within an accommodating space of the first articulated arm segment. In this context, the first articulated arm segment may in particular include a longitudinal frame element with a U-shaped cross-section, the first longitudinal frame element being configured and dimensioned to receive the second articulated arm segment in the stowed configuration. In this latter context, the longitudinal frame element may in particular be produced from a planar sheet or plate of material that is shaped by folding or moulding to exhibit the U-shaped cross-section. Even more preferably, each one of the articulated arm segments may include a longitudinal frame element with a U-shaped cross-section, and each longitudinal frame element may advantageously be produced from a planar sheet or plate of material that is shaped by folding or moulding to exhibit the U-shaped cross-section. In other embodiments, the longitudinal frame element may be produced e.g. by machining from a blank of material, by injection moulding, by sintering or by 3D printing techniques or like additive printing processes.

In accordance with a particularly preferred embodiment, each of the first pivoting joints is located on or close to a front face of the spacecraft, facing the object to be captured. Furthermore, in the stowed configuration, the articulated arm segments are stowed backwards from the front face of the spacecraft, and the articulated arms are deployed forward of the front face of the spacecraft to perform capture of the target space object.

The latter preferred features in effect form a further aspect of the present invention, which is applicable independently of the aforementioned first aspect of the invention. In accordance with a second aspect of the present invention, there is provided a capture system, the features of which are recited in independent claim 8, namely a capture system adapted to capture a target space object, comprising a plurality of articulated arms configured to be deployable from a stowed configuration to a deployed configuration to perform capture of the target space object, wherein each articulated arm includes a plurality of articulated arm segments including a first articulated arm segment coupled at a proximal end to a spacecraft via a first pivoting joint and at least a second articulated arm segment coupled at a proximal end to a distal end of the first articulated arm segment via a second pivoting joint. According to this second aspect of the invention, each of the first pivoting joints is located on or close to a front face of the spacecraft, facing the object to be captured. Furthermore, in the stowed configuration, the articulated arm segments are stowed backwards from the front face of the spacecraft, and the articulated arms are deployed forward of the front face of the spacecraft to perform capture of the target space object.

Advantageously, in the stowed configuration, each of the articulated arm segments is aligned longitudinally alongside lateral sides of the spacecraft.

The latter advantageous features likewise form another aspect of the present invention, which is applicable independently of the aforementioned first and second aspects of the invention. In accordance with a third aspect of the present invention, there is provided a capture system, the features of which are recited in independent claim 10, namely a capture system adapted to capture a target space object, comprising a plurality of articulated arms configured to be deployable from a stowed configuration to a deployed configuration to perform capture of the target space object, wherein each articulated arm includes a plurality of articulated arm segments including a first articulated arm segment coupled at a proximal end to a spacecraft via a first pivoting joint and at least a second articulated arm segment coupled at a proximal end to a distal end of the first articulated arm segment via a second pivoting joint. According to this third aspect of the invention, in the stowed configuration, each of the articulated arm segments is aligned longitudinally alongside lateral sides of the spacecraft.

Even more advantageously, in the stowed configuration, each of the articulated arm segments is aligned along a corresponding longitudinal edge of the spacecraft. Each longitudinal edge may in particular be configured as a recessed section dimensioned to accommodate at least a portion of the articulated arm segments in the stowed configuration. In other embodiments, each of the articulated arm segments may be aligned along a corresponding longitudinal side face of the spacecraft or any other appropriate location alongside lateral sides of the spacecraft.

In accordance with a particularly preferred embodiment, in the stowed configuration, the articulated arm segments are folded one onto the other into a compact folded configuration. In this latter context, each of the first and second pivoting joints may especially be configured such that the first and second articulated arm segments are pivoted in the same direction upon deployment from the stowed configuration to the deployed configuration. Each of the first and second pivoting joints may alternatively be configured such that the first and second articulated arm segments are pivoted in opposite directions upon deployment from the stowed configuration to the deployed configuration.

By way of preference, at least one of the articulated arm segments is provided with a shock-absorbing element configured to come in contact with the space object to be captured.

The latter preferred features likewise form yet another aspect of the present invention, which is applicable independently of the aforementioned first to third aspects of the invention. In accordance with a fourth aspect of the present invention, there is provided a capture system, the features of which are recited in independent claim 17, namely a capture system adapted to capture a target space object, comprising a plurality of articulated arms configured to be deployable from a stowed configuration to a deployed configuration to perform capture of the target space object, wherein each articulated arm includes a plurality of articulated arm segments including a first articulated arm segment coupled at a proximal end to a spacecraft or to a platform deployable from said spacecraft via a first pivoting joint and at least a second articulated arm segment coupled at a proximal end to a distal end of the first articulated arm segment via a second pivoting joint. According to this fourth aspect of the invention, at least one of the articulated arm segments is provided with a shock-absorbing element configured to come in contact with the space object to be captured.

By way of preference, the shock-absorbing element is configured to be reversibly deformable.

The shock-absorbing element may especially comprise a deformable member secured to and protruding away from the articulated arm segment. Advantageously, the deformable member includes a longitudinal element secured at opposite longitudinal ends to the articulated arm segment. In particular, each of the opposite longitudinal ends of the longitudinal element may include securing tabs that are inserted through corresponding mounting slots provided on the articulated arm segment and retained in said mounting slots by retaining elements.

The deformable member may in particular be a convexly curved sheet or plate of material.

Each of the first and second articulated arm segments may advantageously be provided with one said shock-absorbing element.

The shock-absorbing element may in particular be made of or comprise an elastically deformable material, such as a polymer or composite material. Alternatively, the shock-absorbing element may be made of or comprise a plastically deformable material.

In accordance with a particularly preferred embodiment of the invention, each articulated arm further includes a third articulated arm segment coupled at a proximal end to a distal end of the second articulated arm segment via a third pivoting joint.

In this latter context, referring to the first aspect of the invention, both the second and the third articulated arm segments may be nestable, in the stowed configuration, such as to be intertwined with the first articulated arm segment. By way of preference, the third articulated arm segment may be received, in the stowed configuration, within an accommodating space of the second articulated arm segment, which leads to a particularly compact arrangement of the articulated arms in the stowed configuration.

Referring to the aforementioned embodiment, wherein the articulated arm segments are folded one onto the other into a compact folded configuration, in the stowed configuration, the third pivoting joint is preferably configured such that the third articulated arm segment is pivoted in the same direction as the first and second articulated arm segments upon deployment from the stowed configuration to the deployed configuration. This particular configuration and the associated kinematics of actuation of the articulated arms ensure a particularly compact arrangement of the articulated arms in the folded configuration. In other embodiments, the third pivoting joint may however be configured such that the third articulated arm segment is pivoted in the same direction as the first articulated arm segment and in a direction opposite to the direction in which the second articulated arm segment is pivoted.

Referring to the provision of the aforementioned shock-absorbing element, each of the second and third articulated arm segments (as well as, preferably, the first articulated arm segment) may advantageously be provided with one said shock-absorbing element.

By way of preference, the third pivoting joint is configured to have an amplitude of pivoting movement of greater than 180°. The second pivoting joint may advantageously be configured to have an amplitude of pivoting movement of greater than 180° or, conversely, of less than 180°, depending on the relevant kinematics of actuation of the articulated arms. By contrast, the first pivoting joint is preferably configured to have an amplitude of pivoting movement of less than 180°.

Advantageously, each one of the articulated arm segments includes an openwork structure.

By way of preference, each one of the articulated arm segments is made of a lightweight material, such as aluminium, or alloys or composites thereof. Each one of the articulated arm segments may in particular be made of a composite of sandwiched materials.

In accordance with a particularly preferred embodiment, each pivoting joint is equipped with an actuator allowing independent actuation of each articulated arm segment, which ensures great flexibility and adjustably of the capture system with respect to the actual overall shape of the space object to be captured and further provides for a greater ability to cope with a larger variety of relative attitudes between the capture system and the space object to be captured.

By way of preference, each of the articulated arms is provided with one or more sensors selected from the group consisting of proximity sensors, contact sensors, current sensors and force sensors.

Also claimed is a spacecraft comprising the capture system of the invention, as well as uses thereof for the purpose of recovering or deorbiting a space object.

The capture system may especially be coupled to a body of the spacecraft. In this context, the spacecraft may especially comprise a main body with a plurality of substantially parallel longitudinal edges extending along a same direction, each articulated arm being positioned along a corresponding one of the longitudinal edges.

Alternatively, the capture system may be coupled to a platform deployable from the spacecraft, such as a separately deployable space vehicle or unit. For instance, the capture system of the invention could be provided at one end of robotic arm or could be part of an autonomous or remote-controlled vehicle deployed from a service spacecraft.

The spacecraft may further comprise a sensor system designed to assist tracking and/or rendezvous operations with the target space object to be captured. The sensor system may in particular be located along a centreline of the capture system.

Further claimed is a method of capturing a space object using the capture system of the invention, comprising the following steps:
deploying the articulated arms of the capture system from the stowed configuration to an open deployed configuration;
positioning of the capture system with respect to the space object to be captured so that the space object is brought within operating range of the capture system;
closing the articulated arms of the capture system around at least part of the space object; and
locking the articulated arms of the capture system onto the space object so as to prevent any relative movement between the capture system and the space object.

Further advantageous embodiments of the invention form the subject-matter of the dependent claims and are discussed below.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIG. 1A is a schematic perspective view of a spacecraft equipped with a capture system in accordance with an embodiment of the invention, the capture system being shown in a stowed configuration;

FIG. 1B is a schematic perspective view of the spacecraft of FIG. 1A with the capture system shown in a deployed configuration, ready to capture a target space object;

FIG. 2 is a photographic illustration of the “Vespa” (Vega Secondary Payload Adapter) that was used to deliver multiple payloads in Earth orbit on May 7, 2013 as part of the second flight of ESA's Vega launch vehicle;

FIG. 3A is an illustrative image rendering of a spacecraft equipped with a capture system in accordance with an embodiment of the invention, the spacecraft being shown with deployed capture system performing a rendezvous operation with a target space object to be captured;

FIG. 3B is an illustrative image rendering of the spacecraft of FIG. 3A in the process of capturing the target space object, the spacecraft being shown with the capture system being partly closed onto the target space object;

FIG. 4A is a schematic perspective view of a spacecraft equipped with a capture system in accordance with a preferred embodiment of the invention, the capture system being shown in the stowed configuration;

FIG. 4B is a front view of the spacecraft and capture system of FIG. 4A;

FIG. 4C is a side view of the spacecraft and capture system of FIG. 4A;

FIG. 4D is a partial cross-sectional view of a first portion of one of the articulated arms of the capture system of FIGS. 4A-C showing first and third articulated joints of the articulated arm;

FIG. 4E is a partial cross-sectional view of a remaining portion of the articulated arm of FIG. 4D showing a second articulated joint of the articulated arm;

FIG. 5A is a perspective view of an upper portion of a first articulated arm segment of each articulated arm of the capture system of FIGS. 4A-E, which first articulated arm segment includes a U-shaped longitudinal frame element and a shock-absorbing element secured thereto;

FIG. 5B is a perspective view of a lower portion of the first articulated arm segment of FIG. 5A;

FIG. 5C is a front view of the first articulated arm segment of FIGS. 5A-B;

FIG. 5D is a bottom view of the first articulated arm segment of FIGS. 5A-B;

FIG. 6 is a perspective view of a planar sheet or plate of material prior to shaping by folding into the U-shaped longitudinal frame element of FIGS. 5A-D;

FIG. 7A is a perspective view of an upper portion of a second articulated arm segment of each articulated arm of the capture system of FIGS. 4A-E, which second articulated arm segment includes a U-shaped longitudinal frame element and a shock-absorbing element secured thereto;

FIG. 7B is a perspective view of a lower portion of the second articulated arm segment of FIG. 7A;

FIG. 8A is a perspective view of an upper portion of a third articulated arm segment of each articulated arm of the capture system of FIGS. 4A-E, which third articulated arm segment includes a U-shaped longitudinal frame element and a shock-absorbing element secured thereto;

FIG. 8B is a perspective view of a lower portion of the third articulated arm segment of FIG. 8A; and

FIG. 9 is a schematic side view of one articulated arm of the capture system of FIGS. 4A-E shown in a partly deployed state.

### DETAILED DESCRIPTION OF EMBODIMENTS OF THE INVENTION

The present invention will be described in relation to various illustrative embodiments. It shall be understood that the scope of the invention encompasses all combinations and sub-combinations of the features of the embodiments disclosed herein.

As described herein, when two or more parts or components are described as being connected, attached, secured or coupled to one another, they can be so connected, attached, secured or coupled directly to each other or through one or more intermediary parts.

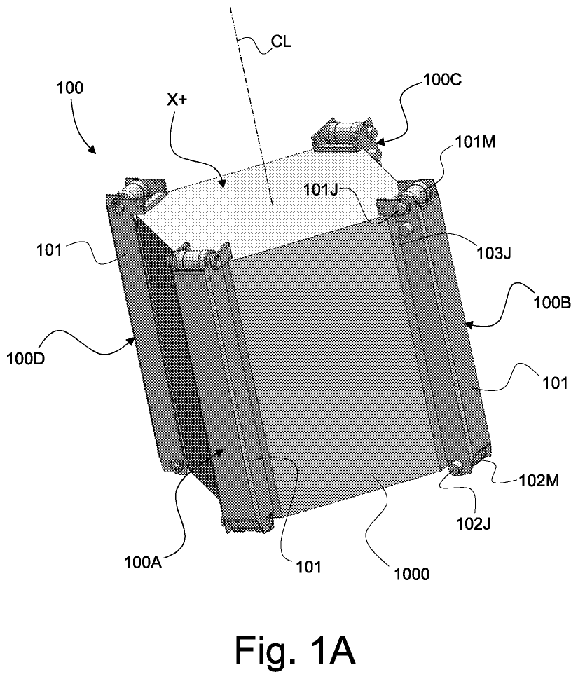

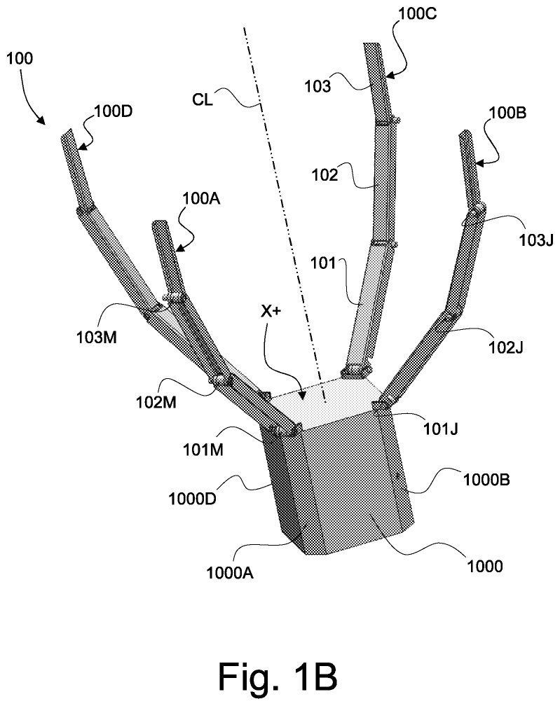

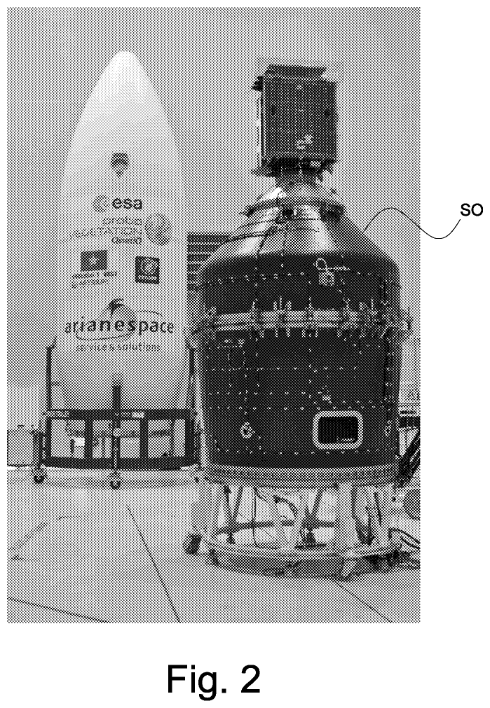

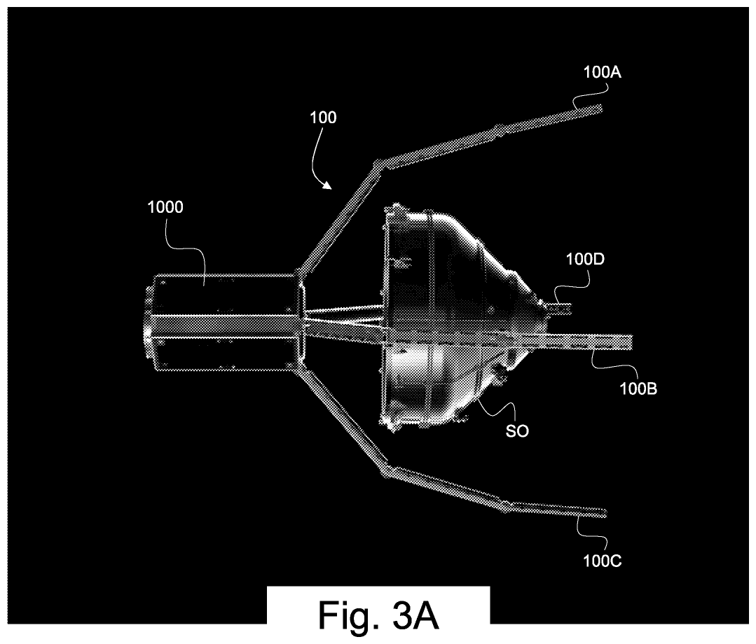

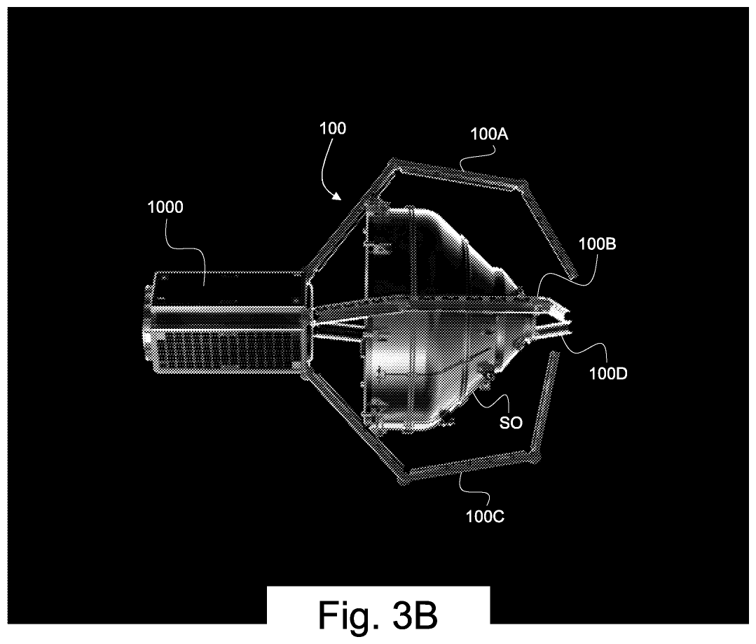

Embodiments of the invention will especially be described hereinafter in the particular context of the capture of part of the “Vespa” (Vega Secondary Payload Adapter), namely the conical upper part of the payload adapter that was used to deliver multiple payloads in Earth orbit on May 7, 2013 during the second Vega flight, VV02, amongst which the ESA's Proba-V satellite. FIG. 2 is a photographic illustration of the Vespa adapter carrying the Proba-V payload, prior to installation within the Vega VV02 fairing. The Proba-V payload is pictured here sitting on top of the conical upper part, designated by reference SO, of the Vespa adapter. The conical upper part SO of the Vespa adapter was left in an approximately 800 km by 660 km altitude orbit around Earth following the VV02 mission. This conical upper part SO, also pictured in FIGS. 3A and 3B, has a mass of the order of 100 kg and an outer diameter of the order of 940 mm, and the capture system that will be described hereafter with reference to FIGS. 1A-B and 3A-B to 9 has been designed taking into account the aforementioned characteristics. It will be understood however that the capture system of the present invention can be used for capturing other types of space objects and is by no means limited solely to the capture of the aforementioned conical upper part of the Vespa adapter.

FIGS. 1A and 1B are schematic illustrations of a spacecraft (also referred to as “chaser”) 1000 equipped with a capture system, generally designated by reference numeral 100, in accordance with an embodiment of the invention. FIGS. 1A and 1B in essence illustrate the basic principle of the capture system 100 of the invention, FIG. 1A showing the capture system 100 in a stowed configuration (which stowed configuration is adopted e.g. during launch of the spacecraft 1000), while FIG. 1B shows the capture system 100 in an open deployed configuration (which deployed configuration is especially adopted prior to approaching the space object and performing a capture attempt, as depicted e.g. in FIG. 3A).

In the illustrated embodiment, the capture system 100 comprises four articulated arms 100A, 100B, 100C, 100D that are coupled to the spacecraft 1000. In other embodiments, the capture system could be coupled to a dedicated platform deployable from the spacecraft 1000. Any number of articulated arms could however be contemplated, namely two or more articulated arms, depending on the mission requirements and the type of space object to be captured. In some instances, two articulated arms might be sufficient to achieve adequate capture of the space object. Considering the contemplated application mentioned above, the use of four articulated arms is preferred in that the space object SO to be captured exhibits a cylindrical symmetry, namely consists of a substantially conical solid of revolution around a main longitudinal axis (see FIGS. 2, 3A and 3B).

The spacecraft 1000 here advantageously comprises a main body of substantially parallelepipedic shape, each articulated arm 100A, 100B, 100C, 100D being positioned along a corresponding longitudinal edge 1000A, 1000B, 1000C, resp. 1000D of the spacecraft 1000. More specifically, each articulated arm 100A, 100B, 100C, 100D includes a plurality of articulated arm segments 101, 102, 103 including at least a first articulated arm segment 101 (or “proximal arm segment”) and a second articulated arm segment 102 (or “intermediate arm segment”). In the illustrated embodiment, each articulated arm 100A, 100B, 100C, 100D advantageously further comprises a third articulated arm segment (or “distal arm segment”).

More specifically, the first articulated arm segment 101 is coupled at a proximal end to the spacecraft 1000 via a first pivoting joint 101J and the second articulated arm segment 102 is coupled at a proximal end to a distal end of the first articulated arm segment 101 via a second pivoting joint 102J. By the same token, the third articulated arm segment 103 is coupled at a proximal end to a distal end of the second articulated arm segment 102 via a third pivoting joint 103J.

In the illustrated embodiment, a front face X+ of the spacecraft 1000 is in essence used as a deployment platform for the articulated arms 100A-D and each of the first pivoting joints 101J is located on the front face X+. The first pivoting joints 101J may be located along the longitudinal edges 1000A-1000D, on or close to the front face X+, thereby allowing to make use of substantially all of the longitudinal length of the spacecraft body for the purpose of stowing the articulated arms 100A-D (as explained hereafter). It is however also possible to locate the first pivoting joints 101J at a certain distance away from the front face X+ of the spacecraft 100 if necessary. Positioning of the first pivoting joints 101J on or close to the front face X+ of the spacecraft 1000 remains a preferred solution though.

As is already apparent from the schematic illustrations of FIGS. 1A-B, the articulated arm segments 101-103 are here stowed backwards from the front face X+, in the stowed configuration (FIG. 1A), and the articulated arms 100A-D are deployed forward of the front face X+ of the spacecraft 1000 (FIG. 1B) to perform a capture operation (see also FIGS. 3A-B). More specifically, in the stowed configuration, each articulated arm 100A, 100B, 100C, 100D is advantageously stowed such that the articulated arm segments 101-103 are folded one onto the other into a highly compact folded configuration. In the illustrated embodiment, the folded configuration is such that the first articulated arm segment 101 is positioned at an outermost location relative to the second and third articulated arm segments 102 and 103, which end up being interposed between the first articulated arm segment 101 and the relevant longitudinal edge 1000A, 1000B, 1000C, resp. 1000D of the spacecraft 1000, in an intertwined manner.

High compactness, in the stowed configuration, may especially be achieved by designing the first articulated arm segment 101 in such a way as to exhibit an accommodating space that is configured and dimensioned to receive, in the illustrated embodiment, both the second and third articulated arm segments 102 and 103.

In accordance with a particularly preferred embodiment of the invention, each pivoting joint 101J, 102J, 103J is equipped with an actuator 101M, 102M, resp. 103M (such as a suitable motor) allowing independent actuation of each articulated arm segment 101, 102, resp. 103, which provides high flexibility and versatility in terms of actuation of the articulated arms and achievable arm geometries. Actuation of the articulated arms 100A-D could however be achieved by different means, such as by using a common drive actuating the relevant arm segments 101-103 via a cable.

While not specifically shown, each of the articulated arms 100A-D may be provided with one or more sensors selected from the group consisting of proximity sensors, contact sensors, current sensors and force sensors. Force sensors could in particular be integrated in each pivoting joint to measure e.g. a torque generated at each pivoting joint. Current sensors could similarly be integrated in each actuator to measure actual power consumption at each pivoting joint. Contact sensors and/or proximity sensors could also be integrated on each articulated arm segment 101, 102, 103 to detect contact or proximity with the space object SO to be captured.

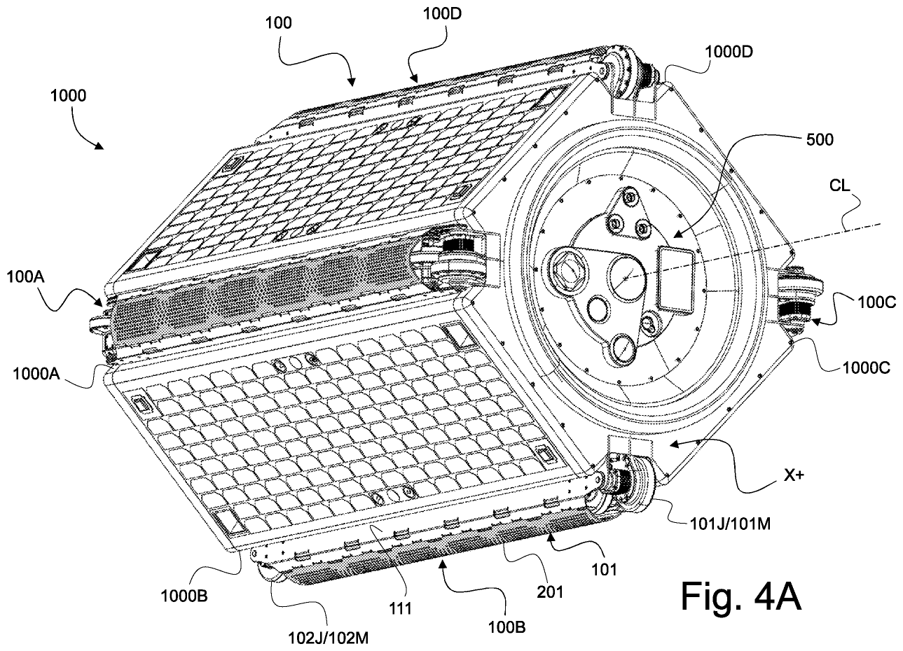

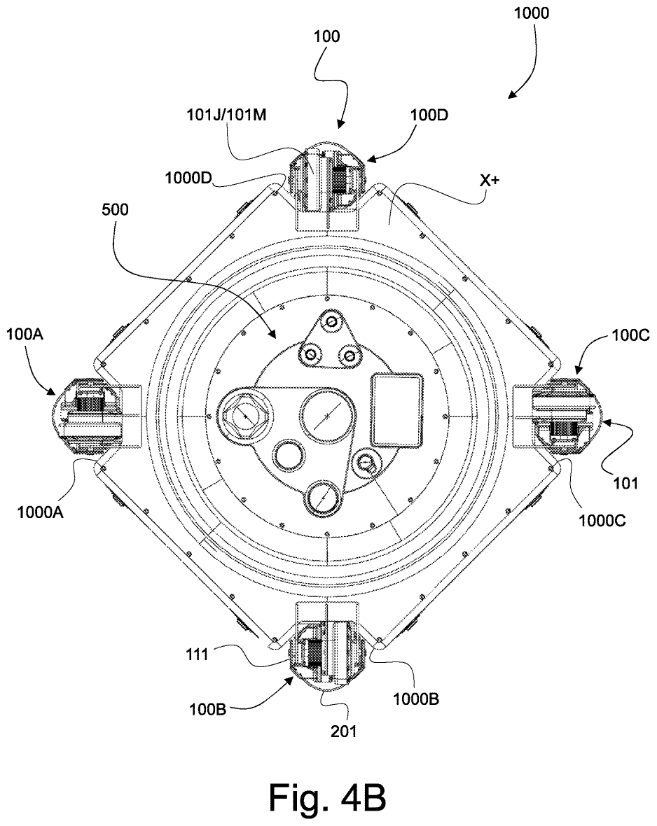

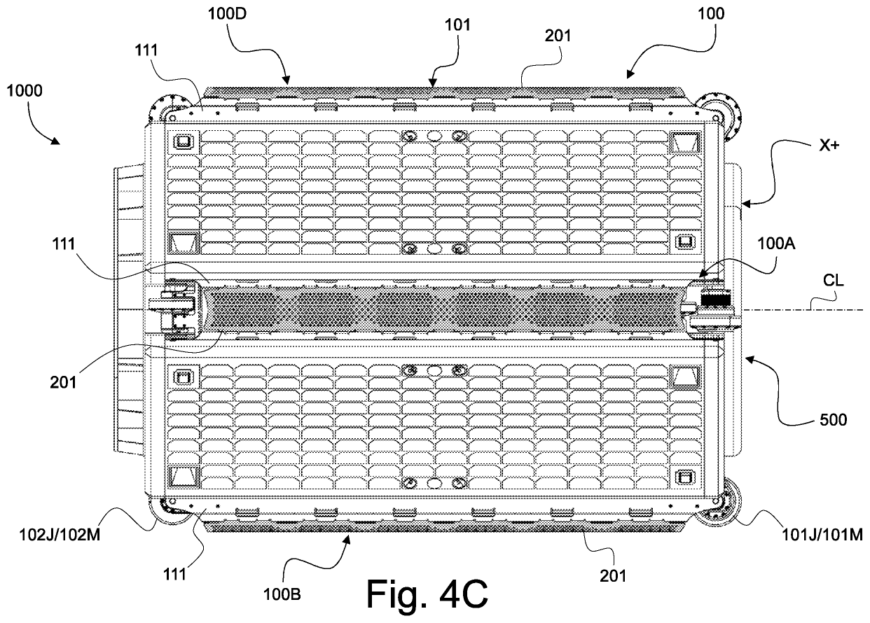

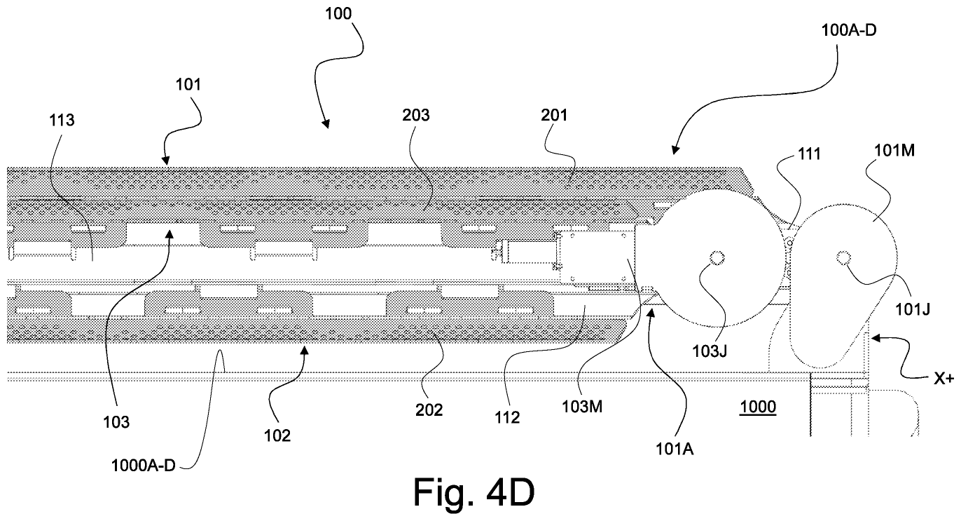

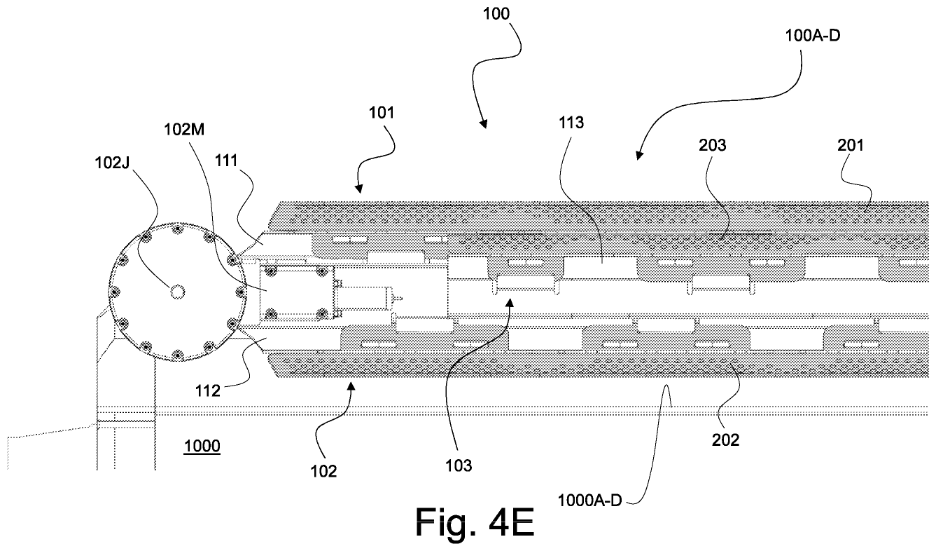

In the illustrated embodiment, one may further note that the four articulated arms 100A-D are advantageously distributed uniformly about a centreline, designated CL, which coincides with a main longitudinal axis of the spacecraft 1000. While not specifically shown in FIGS. 1A-B, it will be understood that the front face X+ of the spacecraft 1000 in particular provides room for the provision of a suitable sensor system designed e.g. to assist tracking and/or rendezvous operations with the target space object (see e.g. FIGS. 4A-C where such a sensor system is shown and designated by reference numeral 500).

FIGS. 3A and 3B are illustrative image renderings of a spacecraft 1000 equipped with a capture system 100 following the principle that has been discussed with reference to FIGS. 1A-B, the capture system 100 being shown in FIG. 3A in a deployed state, performing a rendezvous operation with the target space object SO to be captured. FIG. 3B shows the capture system 100 in a deployed, partly closed state, with the articulated arms 100A-D in the process of being closed around the target space object SO so as to embrace or envelop it. FIGS. 3A-B illustrate the comparatively large operational volume covered by the capture system 100 in the deployed configuration.

While not specifically illustrated, it shall be understood that the articulated arms 100A-D are closed onto the target space object SO so as to create an intimate and robust connection between the capture system 100 and the space object SO, thereby preventing any relative movement between the capture system 100 and the space object SO. In effect, upon completing the capture operation, the articulated arms 100A-D are preferably locked onto the space object SO to prevent any dislodgment or release of the space object SO from the capture system 100.

FIGS. 4A-E are schematic views of a spacecraft 1000 equipped with a capture system 100 in accordance with a preferred embodiment of the invention, the capture system 100 being shown in the stowed configuration. The capture system 100 depicted in FIGS. 4A-E likewise follows the same principle as generically illustrated by FIGS. 1A-B, the same references being used to designate the same features and components of the spacecraft 1000 and capture system 100 discussed hereabove.

Each articulated arm 100A, 100B, 100C, 100D is shown in the stowed configuration, positioned along a corresponding longitudinal edge 1000A, 1000B, 1000C, resp. 1000D of the spacecraft 1000, with the articulated arm segments 101-103 stowed backwards from the front face X+ of the spacecraft 1000 in an intertwined manner. Each of the first pivoting joints 101J is likewise located on the front face X+ of the spacecraft 1000. As this will be more clearly apparent from the following description of FIGS. 4D and 4E, each of the articulated arm segments 101-103 is aligned, in the stowed configuration, alongside lateral sides of the spacecraft, namely along each of the aforementioned longitudinal edges 1000A-D.

In the illustrated embodiment shown in FIGS. 4A-D, each longitudinal edge 1000A-D is advantageously configured as a recessed section dimensioned to accommodate at least a portion of the articulated arm segments 101-103 in the stowed configuration. In this way, lateral sides of the spacecraft 1000 are freed and can optimally be exploited for the purpose of locating suitable solar panels as well as individual attitude thrusters used to control attitude of the spacecraft, the articulated arms 100A-D being ideally positioned about the spacecraft 1000 to avoid any interference with operation of the aforementioned solar panels and/or attitude thrusters.

FIGS. 4A and 4B also show the aforementioned sensor system 500 designed to assist tracking and/or rendezvous operations with the target space object to be captured, which sensor system 500 is ideally positioned on the front face X+ of the spacecraft 1000, along the centreline CL of the capture system 100.

FIGS. 4D and 4E are cross-sectional views of front and rear sections of the articulated arms 100A-D in the stowed configuration, the articulated arm segments 101-103 being shown folded one onto the other into a compact folded configuration. Visible in FIG. 4D are the first and third pivoting joints 101J, 103J, respectively (and associated actuators 101M, 103M) that are respectively provided at the proximal end of the first and third articulated arm segments 101, 103. Visible in FIG. 4E is, likewise, the second pivoting joint 102J (and associated actuator 102M) that is provided at the proximal end of the second articulated arm segment 102.

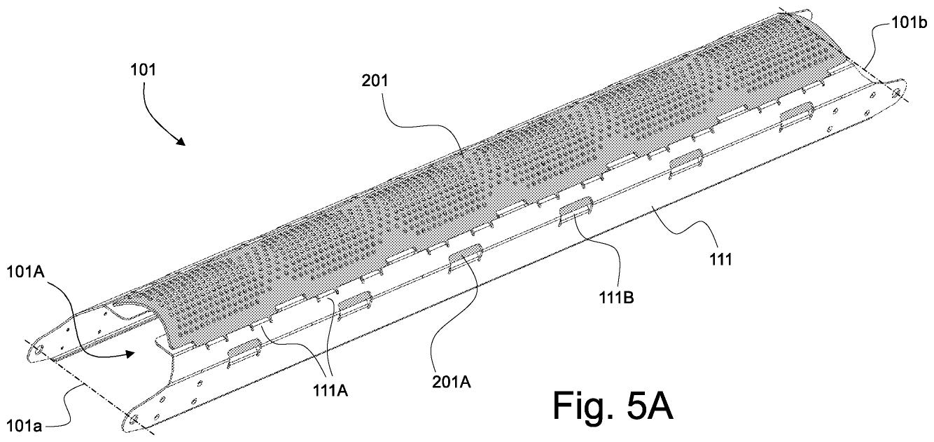

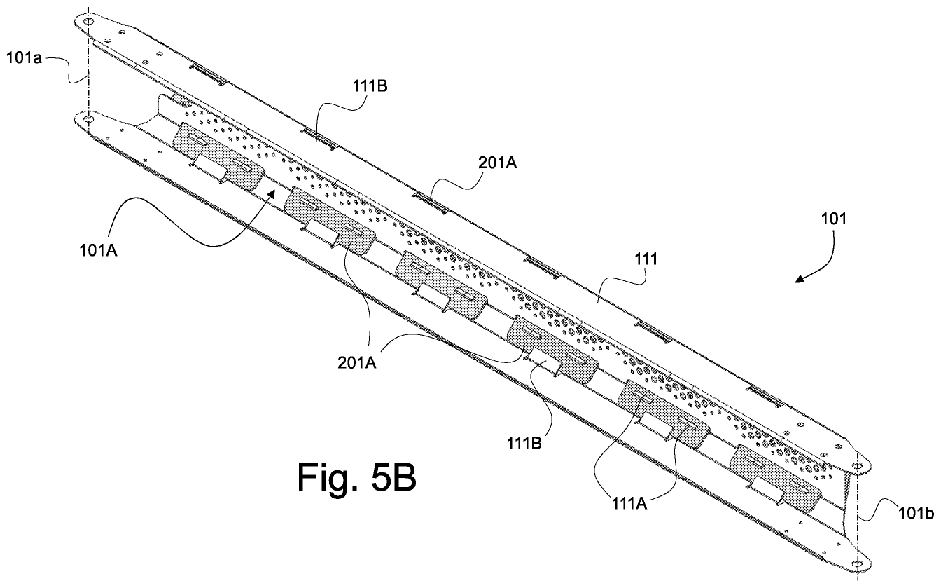

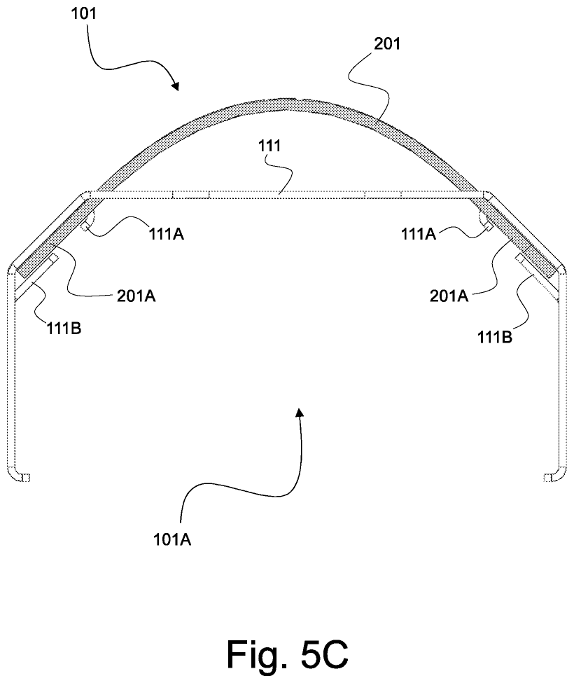

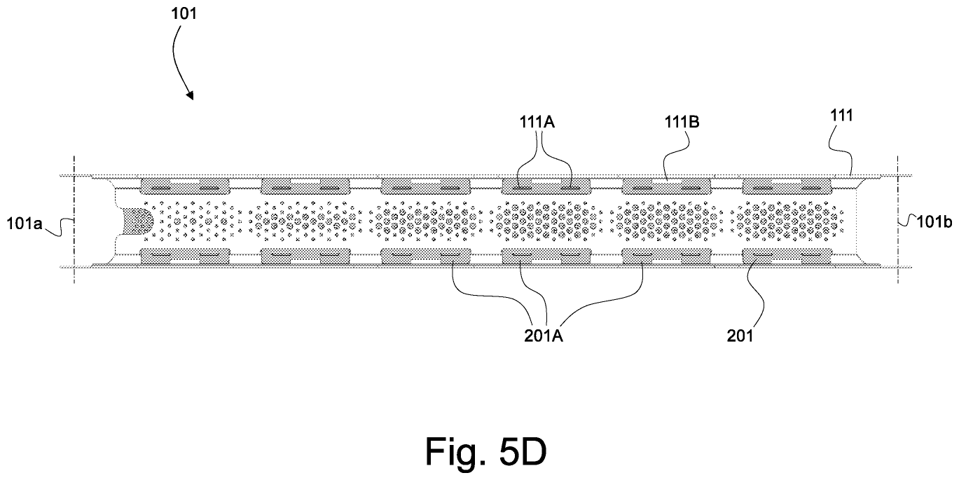

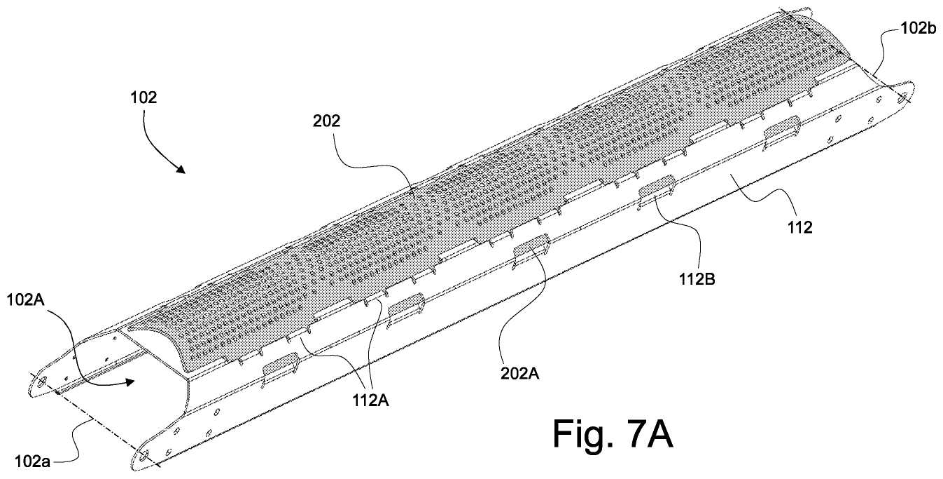

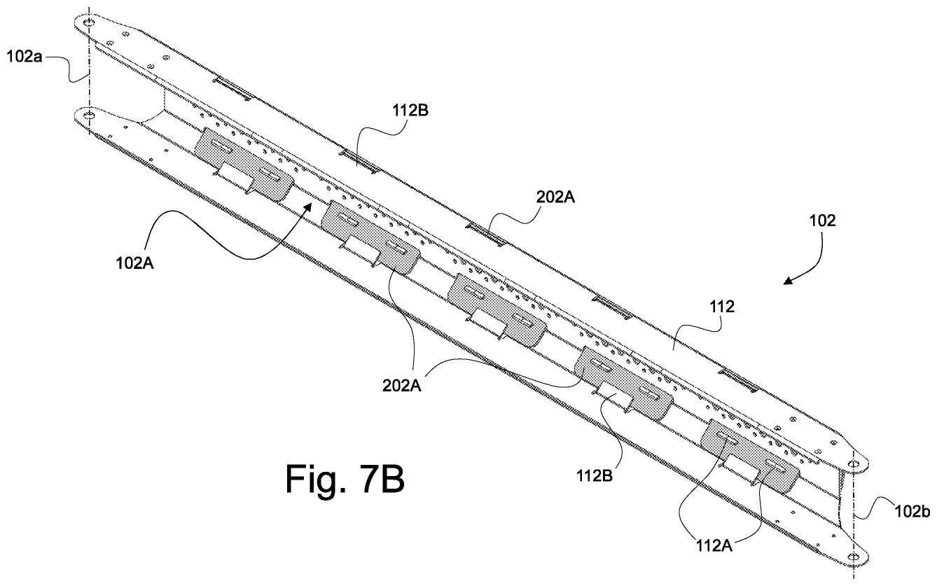

FIGS. 4D and 4E further show that both the second and third articulated arm segments 102, 103 are at least partly received, in the stowed configuration, within an accommodating space 101A of the first articulated arm segment 101, thus lead to intertwining of the articulated arm segments 101-103 in the stowed configuration. In that respect, at least the first articulated arm segment 101 includes a longitudinal frame element 111 with a U-shaped cross-section (shown separately in FIGS. 5A-D), which first longitudinal frame element 111 is configured and dimensioned to receive the second and third articulated arm segments 102, 103 in the stowed configuration. In the illustrated embodiment, each of the second and third articulated arm segments 102, 103 likewise includes a longitudinal frame element 112, resp. 113, with a U-shaped cross-section (shown separately in FIGS. 7A-B and 8A-B), the second longitudinal frame element 112 being similarly configured and dimensioned to receive the third articulated arm segment 103 in the stowed configuration. Other cross-sectional shapes and geometries could be contemplated, while still achieving intertwining of the articulated arm segments 101-103 in the stowed configuration.

Further advantageous features of the capture system 100 of FIGS. 4A-E will now be described in greater detail with reference to FIGS. 5A-D to 8A-B.

FIGS. 5A-D are various views of the first articulated arm segment 101 visible in FIGS. 4A-E, including the aforementioned longitudinal frame element 111. Reference signs 101a, 101b in FIGS. 5A-C respectively designate the proximal and distal ends of the first articulated arm segment 101, which ends 101a, 101b respectively coincide with the relevant pivoting axes of the first and second pivoting joints 101J, 102J. As already mentioned, the longitudinal frame element 111 exhibits a U-shaped cross-section forming an accommodating space 101A suitably configured and dimensioned to receive the second articulated arm segment 102 in the stowed configuration.

FIGS. 7A-B are two perspective views of the second articulated arm segment 102 visible e.g. in FIGS. 4D-E, including the aforementioned longitudinal frame element 112. Reference signs 102a, 102b in FIGS. 7A-B respectively designate the proximal and distal ends of the second articulated arm segment 102, which ends 102a, 102b respectively coincide with the relevant pivoting axes of the second and third pivoting joints 102J, 103J. As already mentioned, the longitudinal frame element 112 exhibits a U-shaped cross-section forming an accommodating space 102A suitably configured and dimensioned to receive the third articulated arm segment 103 in the stowed configuration.

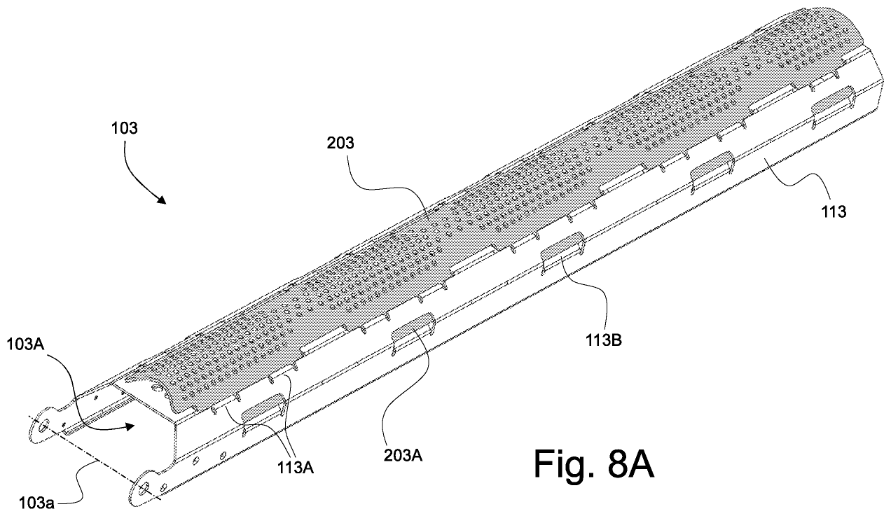

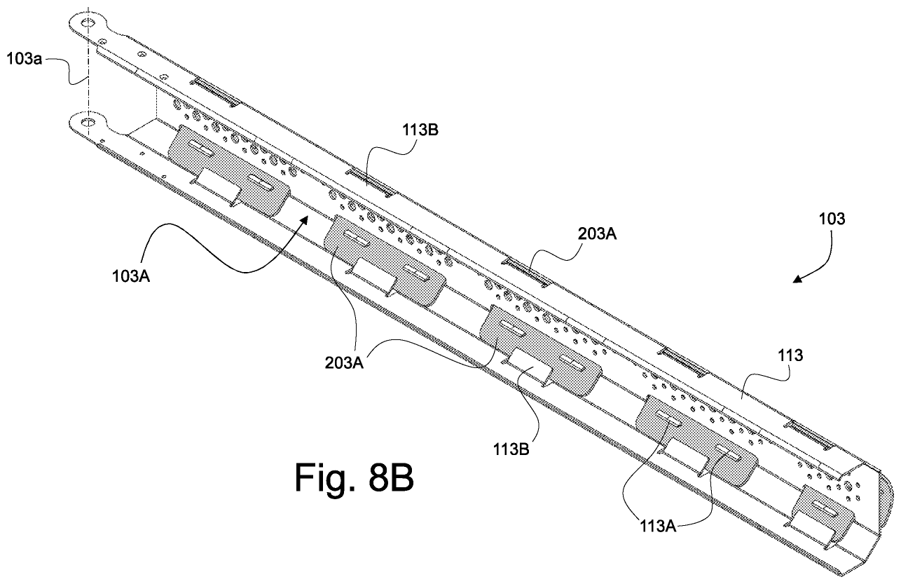

FIGS. 8A-B are two perspective views of the third articulated arm segment 103 visible e.g. in FIGS. 4D-E, including the aforementioned longitudinal frame element 113. Reference sign 103a in FIGS. 8A-B designates the proximal end of the third articulated arm segment 103, which coincides with the pivoting axis of the third pivoting joints 103J. The longitudinal frame element 113 likewise exhibits a U-shaped cross-section forming an accommodating space 103A.

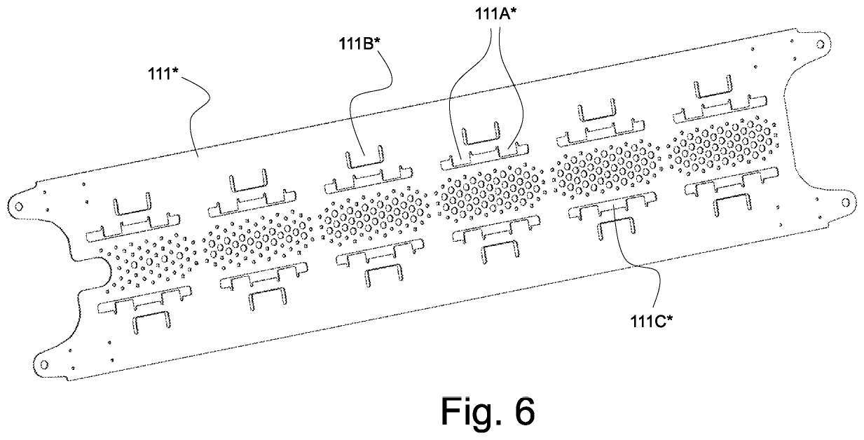

The longitudinal frame elements 111, 112, 113 exhibit substantially the same overall configuration and are preferably produced from a planar sheet or plate of material that is shaped to exhibit the U-shaped cross-section. Shaping into the U-shaped configuration can conveniently be achieved by folding or moulding. In the illustrated embodiment, each longitudinal frame element 111, 112, 113 is preferably formed by folding from a planar, stamped plate of material (e.g. an aluminium plate) as will now be described with reference to FIG. 6 in connection with the longitudinal frame element 111. It will be understood that the longitudinal frame elements 112, 113 are produced in a similar manner.

In other embodiments, the longitudinal frame elements 111, 112, 113 could be produced by other means, for instance by machining a blank of material, by sintering, by injection moulding, or by 3D printing techniques or like additive printing processes.

FIG. 6 is a perspective view of a planar sheet or plate of material, designated by reference sign 111*, prior to shaping into the U-shaped longitudinal frame element 111. The planar sheet or plate 111* can conveniently be produced by stamping and then subjected to folding operations to shape the planar sheet or plate 111* into the desired longitudinal frame element 111. This is not only cost-efficient to produce, but moreover leads to a lightweight, yet robust construction.

By way of preference, each one of the articulated arm segments 101, 102, 103, or more precisely each of the longitudinal frame elements 111, 112, 113, is made of a lightweight material, such as aluminium, or alloys or composites thereof. Use of a composite of sandwiched materials could in particular be contemplated.

As further shown in FIGS. 5A-D to 8A-B, lightweight construction can be further improved by structuring the frame elements 111, 112, 113 to exhibit an openwork structure, i.e. a structure with apertures and/or through-holes designed to reduce weight without compromising structural integrity or robustness. This can conveniently be achieved by stamping a series of holes and apertures into the relevant sheet or plate of material prior to folding. Stamping can furthermore be carried out in such a way as to allow the formation of further structural features such as mounting slots and retaining elements, as further described below.

In accordance with a particularly preferred embodiment of the invention, at least one (preferably multiple or all) of the articulated arm segments is further provided with a shock-absorbing element configured to come in contact with the space object to be captured. In the embodiment illustrated in FIGS. 4A-E to 8A-B, each of the articulated arm segments 101, 102, 103 is in effect provided with such a shock-absorbing element designated by reference numerals 201, 202 and 203, respectively.

In the illustrated embodiment, each shock-absorbing element is especially configured to be reversibly deformable. Advantageously, each shock-absorbing element comprises a deformable member 201, 202, 203 that is secured to and protruding away from the associated articulated arm segment 101, 102, 103. In the illustrated embodiment, each deformable member 201, 202, 203 includes a longitudinal element that is conveniently secured at opposite longitudinal ends to the articulated arm segment 101, 102, 103, namely to the relevant longitudinal frame element 111, 112, 113. In the illustrated embodiment, the deformable member 201, 202, 203 takes the shape of a convexly curved sheet or plate of material, but other embodiments could be contemplated while ensuring a shock-absorbing function.

By way of preference, the shock-absorbing element 201, 202, resp. 203 is made of or comprises an elastically deformable material, such as a polymer or composite material (other material being conceivable). In other embodiments, the shock-absorbing element 201, 202, resp. 203 may be made of or comprise a plastically deformable material. As shown in FIGS. 5A-D, 7A-B and 8A-B, each of the shock-absorbing element 201, 202, 203 may likewise include an openwork structure.

Referring to the illustrations of FIGS. 5A-D, 7A-B and 8A-B, each of the opposite longitudinal ends of the longitudinal element 201, 202, 203 includes securing tabs 201A, 202A, resp. 203A that are inserted through corresponding mounting slots provided on the articulated arm segment 101, 102, 103. These securing tabs 201A, 202A, 203A are secured and retained in the relevant mounting slots by a series of retaining elements 111A-B, 112A-B, resp. 113A-B, as shown in FIGS. 5A-D, 7A-B and 8A-B, thereby leading to a particularly simple overall construction.

Referring again to FIG. 6 and the illustrative example of the first articulated arm segment 101 (which principles apply by analogy to the second and third articulated arm segments 102, 103), one will understand that tabs 111A*, 111B* are formed in the relevant planar sheet or plate of material 111*, which tabs 111A*, 111B* are ultimately shaped into the desired retaining elements 111A, resp. 111B. One will likewise understand that apertures 111C* are formed in the relevant planar sheet or plate of material 111*, which apertures 111C* are ultimately shaped into the desired mounting slots dimensioned to allow attachment of the relevant securing tabs 201A of the longitudinal element 201.

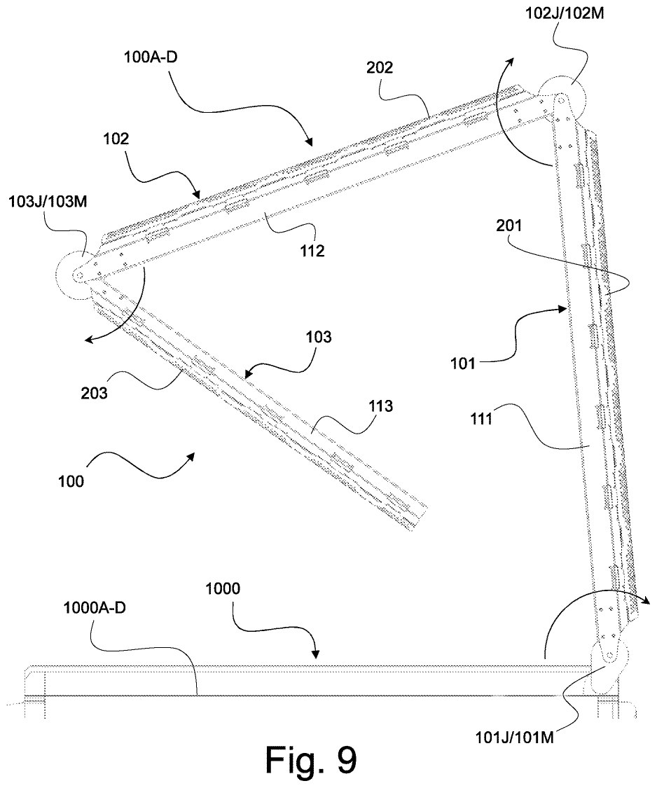

FIG. 9 is a schematic side view of one articulated arm 100A, 100B, 100C, resp. 100D of the capture system 100 of FIGS. 4A-E shown in a partly deployed state.

Looking at FIG. 9, one may especially appreciate that each of the first and second pivoting joints 101J, 102J are configured such that the first and second articulated arm segments 101, 102 are pivoted in the same direction upon deployment from the stowed configuration to the deployed configuration (namely in the clockwise in the illustrated configuration). In effect, referring to the illustrated embodiment, the third pivoting joint 103J is likewise configured such that the third articulated arm segment 103 is pivoted in the same direction as the other articulated arm segments 101, 102.

One may further appreciate that, in the illustrated embodiment, the second and third pivoting joints 102J, 103J are both configured to have an amplitude of pivoting movement of greater than 180°, while the first pivoting joint 101J is configured to have an amplitude of pivoting movement of less than 180°. In other embodiments, the relevant amplitudes of pivoting movement of the pivoting joints could however be different.

This particular configuration and the associated kinematics of actuation of the articulated arms 100A-D ensure a particularly compact arrangement of the articulated arms 100A-D in the folded configuration as shown in the illustrations of FIGS. 4A-E, without compromising in any way the operating capabilities of the capture system 100.

Other configurations and kinematics of actuation of the articulated arms could however be contemplated within the framework of the invention. In particular, all of the pivoting joints do not necessarily need to be configured such that the associated articulated arm segments are pivoted in the same direction upon deployment from the stowed configuration. For instance the articulated arms may be configured such that the first (proximal) arm segment is brought to an innermost position in the stowed configuration (which requires a corresponding adaptation of the structure of the first arm segment), with the second and e.g. third arm segments folded onto an outer portion of the first arm segment in a Z-shaped folding pattern. In such case, the second pivoting joint would be configured such that the second articulated arm segment is pivoted, upon deployment from the stowed configuration, in a direction opposite to the direction in which the first and third articulated arm segments are pivoted. In this latter case, and in contrast to the illustrated embodiments, the second pivoting joint would preferably be configured to have an amplitude of pivoting movement of less than 180°.

Based on the above description, it will be understood that various aspects of the invention are contemplated, which aspects are applicable independently from one another or, preferably, in combination. All aspects relate to a capture system adapted to capture a target space object, which capture system comprises a plurality of articulated arms configured to be deployable from a stowed configuration to a deployed configuration to perform capture of the target space object. According to the invention, each articulated arm includes a plurality of articulated arm segments including a first articulated arm segment coupled at a proximal end to a spacecraft (or to a platform deployable from said spacecraft as the case may be) via a first pivoting joint and at least a second articulated arm segment coupled at a proximal end to a distal end of the first articulated arm segment via a second pivoting joint.

According to a first aspect of the invention, the capture system is such that the plurality of articulated arm segments are nestable one within the other, in the stowed configuration, such that the first and second articulated arm segments are intertwined.

According to a second aspect of the invention, the capture system is such that each of the first pivoting joints is located on or close to a front face of the spacecraft facing the object to be captured, that, in the stowed configuration, the articulated arm segments are stowed backwards from the front face of the spacecraft, and that the articulated arms are deployed forward of the front face of the spacecraft to perform capture of the space object.

According to a third aspect of the invention, the capture system is such that, in the stowed configuration, each of the articulated arm segments is aligned longitudinally alongside lateral sides of the spacecraft.

According to a fourth aspect of the invention, the capture system is such that at least one of the articulated arms (preferably multiple ones) is provided with a shock-absorbing element configured to come in contact with the space object to be captured.

Various modifications and/or improvements may be made to the above-described embodiments without departing from the scope of the invention as defined by the appended claims. For instance, it should be appreciated that the capture system of the invention may comprise any number of articulated arms and that the invention is by no means specifically limited to the use of four articulated arms. A minimum of two could be contemplated, the number of articulated arms preferably ranging from three to five in practice.

Similarly, although the illustrated embodiments show articulated arms each including three articulated arm segments, each articulated arm may include any suitable number of articulated arm segments, including a minimum of two arm segments and more than three arm segments if necessary or appropriate.

Furthermore, although the embodiments disclosed herein show a capture system adapted to capture the conical upper part of the Vespa adapter, the capture system could be adapted to the capture of any other space object.

Moreover, while the spacecraft shown in the Figures comprises a main body exhibiting a substantially parallelepipedic shape with four longitudinal edges, any other suitable shape could be contemplated. In particular, according to an embodiment of the invention, the spacecraft may comprise a main body with a plurality of substantially parallel longitudinal edges extending along a same direction, each articulated arm being positioned along a corresponding one of the longitudinal edges. Any number of longitudinal edges and articulated arms could be contemplated, in particular ranging from two to five or more.

It should also be appreciated that, in order for the articulated arm segments to be intertwined, other cross-sectional shapes than U-shaped cross-sections could be contemplated, including without any limitation L-shaped and T-shaped cross-sections, as long as the articulated arm segments exhibit mutually complementary configurations, geometries and dimensions. In that respect, the relevant cross-sectional shapes could differ from one articulated arm segment to the other.

### LIST OF REFERENCE NUMERALS AND SIGNS USED THEREIN

100 capture system (embodiments of invention)
100A first articulated arm of capture system 100
100B second articulated arm of capture system 100
100C third articulated arm of capture system 100
100D fourth articulated arm of capture system 100
101 first articulated arm segment of articulated arm 100A, 100B, 100C, resp. 100D
101a proximal end of first articulated arm segment 101 (pivotally coupled to spacecraft 1000)
101b distal end of first articulated arm segment 101 (pivotally coupled to proximal end 102a of second articulated arm segment 102)
101A accommodating space of first articulated arm segment 101 (configured and dimensioned to receive second and third articulated arm segments 102, 103 in the stowed configuration)
101J first pivoting joint providing articulation of a proximal end of the first articulated arm segment 101 onto the spacecraft 1000
101M first actuator (e.g. electric motor) providing actuation of the first articulated arm segment 101 at the first pivoting joint 101J
102 second articulated arm segment of articulated arm 100A, 100B, 100C, resp. 100D
102a proximal end of second articulated arm segment 102 (pivotally coupled to distal end 101b of first articular arm segment 101)
102b distal end of second articulated arm segment 102 (pivotally coupled to proximal end 103a of third articulated arm segment 103)
102A accommodating space of second articulated arm segment 102 (configured and dimensioned to receive third articulated arm segment 103 in the stowed configuration)
102J second pivoting joint providing articulation of a proximal end of the second articulated arm segment 102 onto a distal end of the first articulated arm segment 101
102M second actuator (e.g. electric motor) providing actuation of the second articulated arm segment 102 at the second pivoting joint 102J
103 third articulated arm segment of articulated arm 100A, 100B, 100C, resp. 100D
103a proximal end of third articulated arm segment 103 (pivotally coupled to distal end 102b of second articular arm segment 101)
103A accommodating space of third articulated arm segment 103
103J third pivoting joint providing articulation of a proximal end of the third articulated arm segment 103 onto a distal end of the second articulated arm segment 102
103M third actuator (e.g. electric motor) providing actuation of the third articulated arm segment 103 at the third pivoting joint 103J
111 (first) longitudinal frame element of first articulated arm segment 101
111A retaining elements for securing tabs 201A
111B retaining elements for securing tabs 201A
111* planar sheet/plate of material prior to shaping (e.g. by folding) into longitudinal frame element 111
111A* tabs in planar sheet/plate of material 111* prior to shaping (e.g. by folding) into retaining elements 111A
111B* tabs in planar sheet/plate of material 111* prior to shaping (e.g. by folding) into retaining elements 111B
111C* apertures in planar sheet/plate of material 111* prior to shaping (e.g. by folding) into mounting slots for securing tabs 201A
112 (second) longitudinal frame element of second articulated arm segment 103
112A retaining elements for securing tabs 202A
112B retaining elements for securing tabs 202A
113 (third) longitudinal frame element of third articulated arm segment 103
113A retaining elements for securing tabs 203A
113B retaining elements for securing tabs 203A
201 (first) shock-absorbing element provided on first articulated arm segment 101/(first) longitudinal element made e.g. of a concavely curved sheet/plate of material secured to longitudinal frame element 111
201A securing tabs protruding from longitudinal sides of longitudinal element 201 for mounting on longitudinal frame element 111
202 (second) shock-absorbing element provided on second articulated arm segment 102/(second) longitudinal element made e.g. of a concavely curved sheet/plate of material secured to longitudinal frame element 112
202A securing tabs protruding from longitudinal sides of longitudinal element 202 for mounting on longitudinal frame element 112
203 (third) shock-absorbing element provided on third articulated arm segment 103/(third) longitudinal element made e.g. of a concavely curved sheet/plate of material secured to longitudinal frame element 113
203A securing tabs protruding from longitudinal sides of longitudinal element 203 for mounting on longitudinal frame element 113
500 sensor system
1000 spacecraft (or “chaser”) equipped with capture system 100
1000A first longitudinal edge along lateral sides of spacecraft 1000 providing space for positioning of first articulated arm 100A in a stowed configuration
1000B second longitudinal edge along lateral sides of spacecraft 1000 providing space for positioning of second articulated arm 100B in a stowed configuration
1000C third longitudinal edge along lateral sides of spacecraft 1000 providing space for positioning of third articulated arm 100C in a stowed configuration
1000D fourth longitudinal edge along lateral sides of spacecraft 1000 providing space for positioning of fourth articulated arm 100D in a stowed configuration
SO space object to be captured
X+ front face of spacecraft 1000 facing space object SO to be captured
CL centreline of capture system 100

1.-49. (canceled)

50. A capture system adapted to capture a target space object, comprising a plurality of articulated arms configured to be deployable from a stowed configuration to a deployed configuration to perform capture of the target space object,
wherein each articulated arm includes a plurality of articulated arm segments including a first articulated arm segment coupled at a first proximal end to a spacecraft, the first articulated arm segment being coupled at the first proximal end via a first pivoting joint,
wherein the plurality of articulated arm segments further includes at least a second articulated arm segment coupled at a second proximal end to a first distal end of the first articulated arm segment via a second pivoting joint,
wherein each of the first pivoting joints is located on or close to a front face of the spacecraft, facing the space object to be captured,
wherein, in the stowed configuration, the articulated arm segments are stowed backwards from the front face of the spacecraft,
and wherein the articulated arms are deployable forward of the front face of the spacecraft to perform capture of the target space object.

51. The capture system according to claim 50, wherein the plurality of articulated arm segments are nestable one within the other, in the stowed configuration, such that the first and second articulated arm segments are intertwined.

52. The capture system according to claim 51, wherein, in the stowed configuration, the second articulated arm segment is received within an accommodating space of the first articulated arm segment.

53. The capture system according to claim 52, wherein the first articulated arm segment includes a longitudinal frame element with a U-shaped cross-section, the longitudinal frame element being configured and dimensioned to receive the second articulated arm segment in the stowed configuration.

54. The capture system according to claim 53, wherein the longitudinal frame element is produced from a planar sheet or plate of material that is shaped by folding or moulding to exhibit the U-shaped cross-section.

55. The capture system according to claim 50, wherein, in the stowed configuration, each of the articulated arm segments is aligned longitudinally alongside lateral sides of the spacecraft.

56. The capture system according to claim 50, wherein, in the stowed configuration, each of the articulated arm segments is aligned along a corresponding longitudinal edge of the spacecraft.

57. The capture system according to claim 56, wherein each longitudinal edge is configured as a recessed section dimensioned to accommodate at least a portion of the articulated arm segments in the stowed configuration.

58. The capture system according to claim 50, wherein, in the stowed configuration, the articulated arm segments are folded one onto the other into a compact folded configuration.

59. The capture system according to claim 50, wherein at least one of the articulated arm segments is provided with a shock-absorbing element configured to come in contact with the space object to be captured.

60. The capture system according to claim 59, wherein the shock-absorbing element is configured to be reversibly deformable.

61. The capture system according to claim 59, wherein the shock-absorbing element comprises a deformable member secured to and protruding away from the articulated arm segment.

62. The capture system according to claim 59, wherein each of the first and second articulated arm segments is provided with one said shock-absorbing element.

63. The capture system according to claim 50, wherein each articulated arm further includes a third articulated arm segment coupled at a third proximal end to a second distal end of the second articulated arm segment via a third pivoting joint.

64. The capture system according to claim 63, wherein both the second and the third articulated arm segments are nestable, in the stowed configuration, such as to be intertwined with the first articulated arm segment.

65. The capture system according to claim 64, wherein the third articulated arm segment is received, in the stowed configuration, within an accommodating space of the second articulated arm segment.

66. The capture system according to claim 63, wherein each of the first and second pivoting joints are configured such that the first and second articulated arm segments are pivoted in the same direction upon deployment from the stowed configuration to the deployed configuration,
and wherein the third pivoting joint is configured such that the third articulated arm segment is pivoted in the same direction as the first and second articulated arm segments upon deployment from the stowed configuration to the deployed configuration.

67. The capture system according to claim 63, wherein each of the first and second pivoting joints are configured such that the first and second articulated arm segments are pivoted in opposite directions upon deployment from the stowed configuration to the deployed configuration,
and wherein the third pivoting joint is configured such that the third articulated arm segment is pivoted in the same direction as the first articulated arm segment upon deployment from the stowed configuration to the deployed configuration.

68. The capture system according to claim 59, wherein each articulated arm further includes a third articulated arm segment coupled at a third proximal end to a second distal end of the second articulated arm segment via a third pivoting joint,
and wherein each of the second and third articulated arm segments is provided with one said shock-absorbing element.

69. The capture system according to claim 63, wherein the third pivoting joint is configured to have an amplitude of pivoting movement of greater than 180°.

70. The capture system according to claim 50, wherein the second pivoting joint is configured to have an amplitude of pivoting movement of greater than 180°.

71. The capture system according to claim 50, wherein the second pivoting joint is configured to have an amplitude of pivoting movement of less than 180°.

72. The capture system according to claim 50, wherein the first pivoting joint is configured to have an amplitude of pivoting movement of less than 180°.

73. The capture system according to claim 50, wherein each one of the articulated arm segments includes an openwork structure.

74. The capture system according to claim 50, wherein each one of the articulated arm segments is made of a lightweight material.

75. The capture system according to claim 74, wherein the lightweight material is aluminium, an aluminium alloy, or an aluminium composite.

76. The capture system according to claim 50, wherein each pivoting joint is equipped with an actuator allowing independent actuation of each articulated arm segment.

77. The capture system according to claim 50, wherein each of the articulated arms is provided with one or more sensors selected from the group consisting of proximity sensors, contact sensors, current sensors and force sensors.

78. A spacecraft comprising a capture system in accordance with claim 50 coupled to a body of the spacecraft.

79. The spacecraft according to claim 78, wherein the spacecraft comprises a main body with a plurality of substantially parallel longitudinal edges extending along a same direction, each articulated arm being positioned along a corresponding one of the longitudinal edges.

80. The spacecraft according to claim 78, further comprising a sensor system designed to assist tracking and/or rendezvous operations with the target space object to be captured.

81. The spacecraft according to claim 80, wherein the sensor system is located along a centreline of the capture system.

82. A method of capturing a space object by means of a capture system comprising a plurality of articulated arms configured to be deployable from a stowed configuration to a deployed configuration to perform capture of the target space object,
wherein each articulated arm includes a plurality of articulated arm segments including a first articulated arm segment coupled at a first proximal end to a spacecraft or to a platform deployable from said spacecraft, the first articulated arm segment being coupled at the first proximal end via a first pivoting joint,
wherein the plurality of articulated arm segments further includes at least a second articulated arm segment coupled at a second proximal end to a first distal end of the first articulated arm segment via a second pivoting joint,
wherein each of the first pivoting joints is located on or close to a front face of the spacecraft, facing the space object to be captured,
wherein, in the stowed configuration, the articulated arm segments are stowed backwards from the front face of the spacecraft,
and wherein the articulated arms are deployable forward of the front face of the spacecraft to perform capture of the target space object,
the method comprising the following steps:
deploying the articulated arms from the stowed configuration to an open deployed configuration such that the articulated arms extend forward of the front face of the spacecraft;
positioning of the capture system with respect to the space object to be captured such that the space object is brought within operating range of the capture system;
closing the articulated arms around at least part of the space object; and
locking the articulated arms onto the space object so as to prevent any relative movement between the capture system and the space object.
